(19) United States
(12) Patent Application Publication
(10) Pub. No.: US 2017/0217752 A1
(43) Pub. Date: Aug. 3, 2017

(54) Drip Collection System

(71) Applicant: Joanne Carryl, East Norwich, NY (US)

(72) Inventor: Joanne Carryl, East Norwich, NY (US)

(21) Appl. No.: 15/014,737

(22) Filed: Feb. 3, 2016

(51) Int. Cl. B67D 3/00; B67D 1/16

(52) U.S. Cl. CPC B67D 3/0058; B67D 1/16; B67D 3/0061

(57) ABSTRACT

A drip collection system includes a cooler that contains a beverage. The cooler has a spout to dispense the beverage from the cooler. The cooler is positioned on a support surface. A container is positioned beneath the cooler. The container captures beverage that leaks from the spout. Thus, the beverage is inhibited from dripping onto a floor.

### BACKGROUND OF THE DISCLOSURE

Field of the Disclosure

The disclosure relates to collection devices and more particularly pertains to a new collection device for collecting beverage that drips from a beverage cooler.

### SUMMARY OF THE DISCLOSURE

An embodiment of the disclosure meets the needs presented above by generally comprising a cooler that contains a beverage. The cooler has a spout to dispense the beverage from the cooler. The cooler is positioned on a support surface. A container is positioned beneath the cooler. The container captures beverage that leaks from the spout. Thus, the beverage is inhibited from dripping onto a floor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a drip collection system according to an embodiment of the disclosure.

FIG. 2 is a top view of an embodiment of the disclosure.

FIG. 3 is a left side view of an embodiment of the disclosure.

FIG. 4 is an exploded perspective view of an alternative embodiment of the disclosure.

FIG. 5 is a perspective in-use view of an embodiment of the disclosure.

### DESCRIPTION OF THE PREFERRED EMBODIMENT

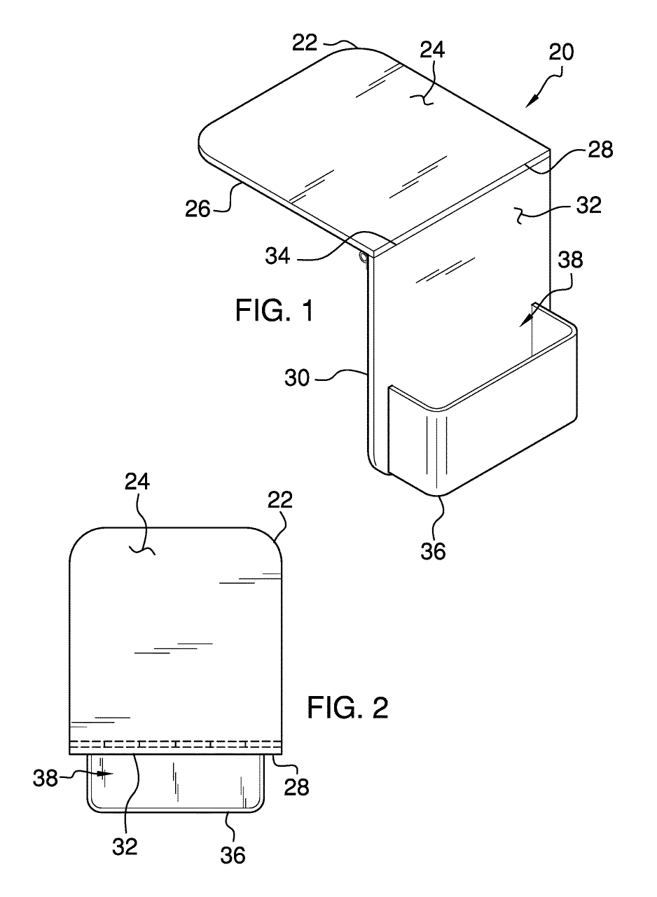

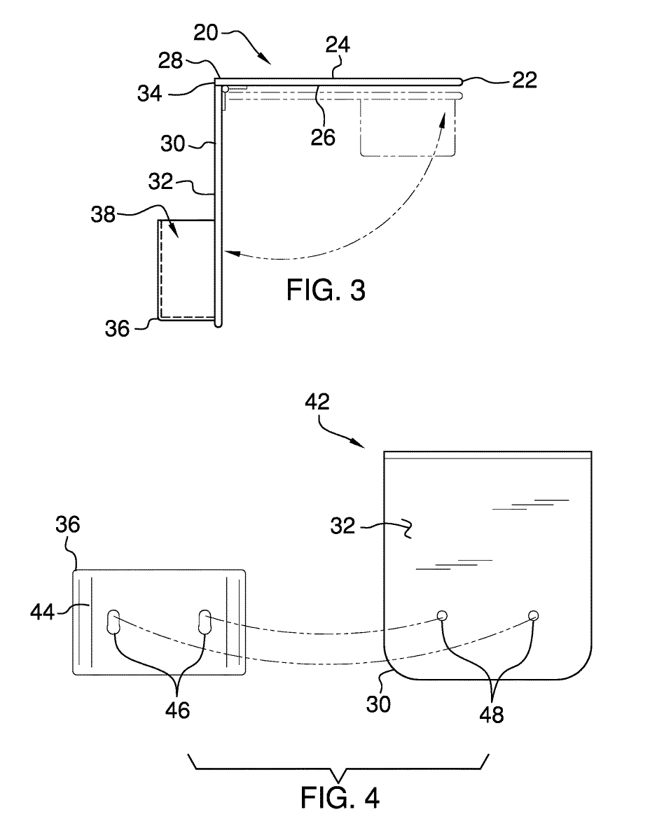

With reference now to the drawings, and in particular to FIGS. 1 through 5 thereof, a new collection device embodying the principles and concepts of an embodiment of the disclosure and generally designated by the reference numeral 10 will be described.

As best illustrated in FIGS. 1 through 5, the drip collection system 10 generally comprises a cooler 12 that may contain a beverage 14. The cooler 12 has a spout 16 and a bottom wall 18. The spout 16 may be manipulated thereby facilitating the spout 16 to dispense the beverage 14 from the cooler 12. The beverage 14 may comprise a liquid beverage or the like. The cooler 12 may comprise a beverage cooler or the like. The cooler 12 may be positioned on a support surface 18 and the support surface 18 may comprise a table top or the like.

A container 20 is positioned beneath the cooler 12 and the container 20 captures beverage 14 that leaks from the spout 16. Thus, the beverage 14 is inhibited from dripping onto a floor. The container 20 comprises a first panel 22 that has a top surface 24, a bottom surface 26 and a front edge 28. The bottom surface 26 may be positioned on the support surface 18 such that the bottom wall 18 of the cooler 12 rests on the top surface 24. Thus, the container 20 is retained on the support surface 18.

A second panel 30 is provided that has a forward surface 32 and a back edge 34. The back edge 34 is hingedly coupled to the front edge 28. Thus, the second panel 30 may hang downwardly from the support surface 18 when the first panel 22 is positioned beneath the cooler 12. The second panel 30 forms a selected angle with respect to the first panel 22.

A cup 36 is coupled to the forward surface 32 of the second panel 30. The cup 36 has a top end 38 and the top end 38 is open. The top end 38 is aligned with the spout 16 when the first panel 22 is positioned beneath the cooler 12. Thus, the top end 38 captures the beverage 14 dripping from the spout 16. The cup 36 is spaced from the first panel 22 to facilitate a vessel 40 to be positioned between the spout 16 and the cup 36. Thus, the vessel 40 may be filled with the beverage 14.

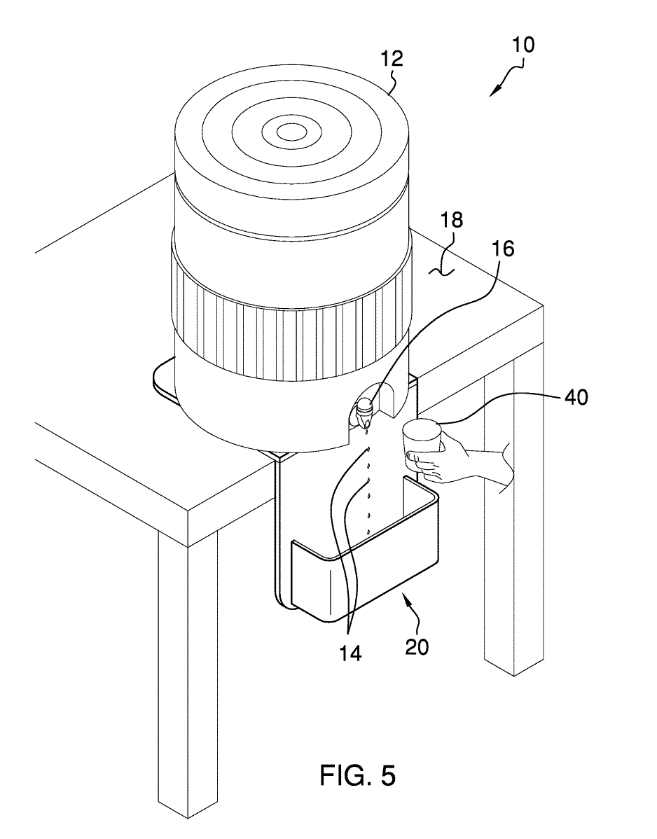

In an alternative embodiment 42 as shown in FIG. 4, the cup 36 has a peripheral wall 44. The peripheral wall 44 may have a pair of wells 46 extending inwardly therein. A pair of pegs 48 may be coupled to the forward surface 32 of the second panel 30. Each of the pegs 48 engages an associated one of the wells 46. Thus, the cup 36 is removably coupled to the second panel 30.

In use, the first panel 22 is placed on the support surface 18. The first panel 22 is positioned adjacent to an outer edge 50 of the support surface 18. Thus, the second panel 30 hangs downwardly from the outer edge 50. The bottom wall 18 of the cooler 12 is positioned on the first panel 22. The cooler 12 is manipulated to align the spout 16 with the top end 38 of the cup 36. The vessel 40 is positioned between the cup 36 and the spout 16 when the vessel 40 is filled with the beverage 14. The cup 36 collects beverage 14 that drips from the spout 16 when the vessel 40 is filled.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A drip collection system comprising:
a cooler being configured to contain a beverage, said cooler having a spout wherein said spout is configured to be manipulated thereby facilitating said spout to dispense the beverage from said cooler, said cooler being configured to be positioned on a support surface;
a container being positioned beneath said cooler wherein said container is configured to capture beverage that leaks from said spout thereby inhibiting the beverage from dripping onto a floor;
a first panel being positioned beneath said cooler;
a second panel having a forward surface; and
a cup being coupled to said forward surface of said second panel, said cup having a top end, said top end being open, said top end being defined by a planar edge extending perpendicularly from said forward surface of said second panel, said top end being aligned with said spout when said first panel is positioned beneath said cooler wherein said top end is configured to capture the beverage dripping from said spout.

2. The system according to claim 1, wherein said container comprises:
said first panel having a top surface, a bottom surface and a front edge, said bottom surface being configured to be positioned on the support surface such that a bottom wall of said cooler rests on said top surface; and
said second panel having a back edge, said back edge being hingedly coupled to said front edge wherein said second panel is configured to hang downwardly from the support surface when said first panel is positioned beneath said cooler.

3. (canceled)

4. The system according to claim 1, wherein said top end of said cup is spaced from said first panel wherein an entirety of said cup is downwardly spaced from said spout and said cup is configured to have a vessel positioned between said spout and said cup thereby facilitating the vessel to be filled with the beverage.

5. A drip collection system comprising:
a cooler being configured to contain a beverage, said cooler having a spout wherein said spout is configured to be manipulated thereby facilitating said spout to dispense the beverage from said cooler, said cooler being configured to be positioned on a support surface, said cooler having a bottom wall; and
a container being positioned beneath said cooler wherein said container is configured to capture beverage that leaks from said spout thereby inhibiting the beverage from dripping onto a floor, said container comprising:
a first panel having a top surface, a bottom surface and a front edge, said bottom surface being configured to be positioned on the support surface such that said bottom wall of said cooler rests on said top surface,
a second panel having a forward surface and a back edge, said back edge being hingedly coupled to said front edge wherein said second panel is configured to hang downwardly from the support surface when said first panel is positioned beneath said cooler, and
a cup being coupled to said forward surface of said second panel, said cup having a top end, said top end being open, said top end being defined by a planar edge extending perpendicularly from said forward surface of said second panel, said top end being aligned with said spout when said first panel is positioned beneath said cooler wherein said top end is configured to capture the beverage dripping from said spout, said top end of said cup being spaced from said first panel wherein an entirety of said cup is downwardly spaced from said spout and said cup is configured to have a vessel positioned between said spout and said cup thereby facilitating the vessel to be filled with the beverage.
